(19) United States
(12) Patent Application Publication
(10) Pub. No.: US 2023/0261448 A1
(43) Pub. Date: Aug. 17, 2023

(54) CABLE PLOW ATTACHMENT

(71) Applicant: Landmark Drainage, LLC, Moorhead, MN (US)

(72) Inventors: Blake Sunde, Dilworth, MN (US); Scot Peck, Perham, MN (US); David Oberg, Moorhead, MN (US)

(21) Appl. No.: 18/170,295

(22) Filed: Feb. 16, 2023

Related U.S. Application Data
(60) Provisional application No. 63/310,898, filed on Feb. 16, 2022.

(51) Int. Cl. H02G 1/06

(52) U.S. Cl. CPC H02G 1/06

(57) ABSTRACT

A cable plow attachment can simultaneously install multiple cables at different depths, varying spacing, and in different configurations based on what construction plans may specify. The cable plow attachment can comprise a frame configured to removably attach to and extend from a cable plow. The frame defines a plurality of slots each configured to removably receive one or more shanks. The one or more shanks can include a first end configured to direct a cable through at least one boot coupled to the shank and a second end configured to excavate and position the cable. The second end has an excavation side facing the direction of forward movement of the cable plow and includes one or more of blades, teeth, and lift plates to dig a groove, and an installation side opposite the excavation side that includes an outlet configured to position the cable in the groove.

### PRIORITY CLAIM

The present application claims priority from U.S. Provisional Application No. 63/310,898, filed Feb. 16, 2022, which is hereby fully incorporated herein by reference.

### TECHNICAL FIELD

The present disclosure relates generally to machinery for laying cable in the ground, and particularly to a cable plow attachment apparatus for simultaneously installing multiple cables.

### BACKGROUND

The laying and placement of cables, wires, tubes, and the like in underground installations has become increasingly common. Underground installation can be desired because of rules and regulations that prohibit or limit above ground installations or simply because doing so produces a more attractive installation without unsightly overhead wires and support structure. As a result, various machines and devices have been developed in the past for cutting a trench or slit in the earth and laying conduits therein.

Conventional methods of laying certain cable, such as DC cable, can require digging an open trench, individually or manually laying the cable in the open trench, and backfilling the trench using machinery. Such methods of installation can be dangerous as they can require large portions of open trench, and inefficient because several crews can be required to complete the various stages of the process.

Therefore, a need exists for a cable plow attachment apparatus for laying underground cable capable of addressing the aforementioned problems.

### SUMMARY

Embodiments of the present disclosure are capable of simultaneously installing multiple cables at different depths, varying spacing, and in different configurations based on what the construction plans are specifying.

In an embodiment, a cable plow attachment can comprise a frame configured to removably attach to and extend from a cable plow. The frame defines a plurality of slots each configured to selectively receive one or more shanks. Each of the one or more shanks include a first end configured to direct one or more cables through one or more boots selectively received by the shank and a second end having an excavation side facing the direction of forward movement of the cable plow and an installation side. The excavation side includes one or more of blades, teeth, and lift plates configured to dig a groove, and the installation side includes an outlet configured to position the cable in the groove.

In embodiments, the cable plow can further include a hydraulic auger coupled to the frame that is configured to outwardly displace dirt and debris.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A and 1B are photographs of a cable plow coupled to a cable plow attachment according to an embodiment.

FIG. 2A is a top-down view of a frame of a cable plow attachment according to an embodiment.

FIG. 2B is a front view of the frame of FIG. 2A.

FIG. 2C is a partial side view of the frame of FIG. 2A.

FIG. 2D is a partial side view of the frame of FIG. 2A.

FIGS. 3A and 3B are partial side views of a cable plow attachment according to an embodiment.

FIG. 4A is a top-down view of a cable plow attachment according to an embodiment.

FIG. 4B is a front view of the cable plow attachment of FIG. 4A.

FIG. 4C is a partial side view of the cable plow attachment of FIG. 4A.

FIG. 5A is a photograph of a front view of a cable plow attachment according to an embodiment.

FIG. 5B is a photograph of a side view of a cable plow attachment according to an embodiment.

FIG. 5C is a photograph of a back view of a cable plow attachment according to an embodiment.

FIGS. 6-11 are photographs of a cable plow attachment in use according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Generally, a conventional method for installing cable underground, such as DC cable necessary for solar farms, requires digging an open trench, individually or manually laying the cable in the open trench, and backfilling the trench using machinery. These steps often require several crews to complete the entire installation process.

These conventional methods of installing cable involves individually spacing the cables from each other. Further, an open trench must be dug and generally remain open during the cable installation process. These exposed open trenches can pose safety risks. Additionally, the open trench must be dewatered if it rains which is costly and time consuming.

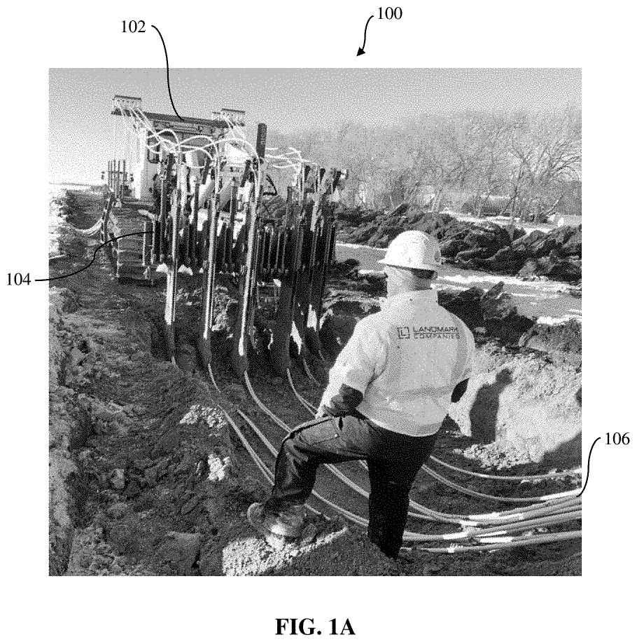

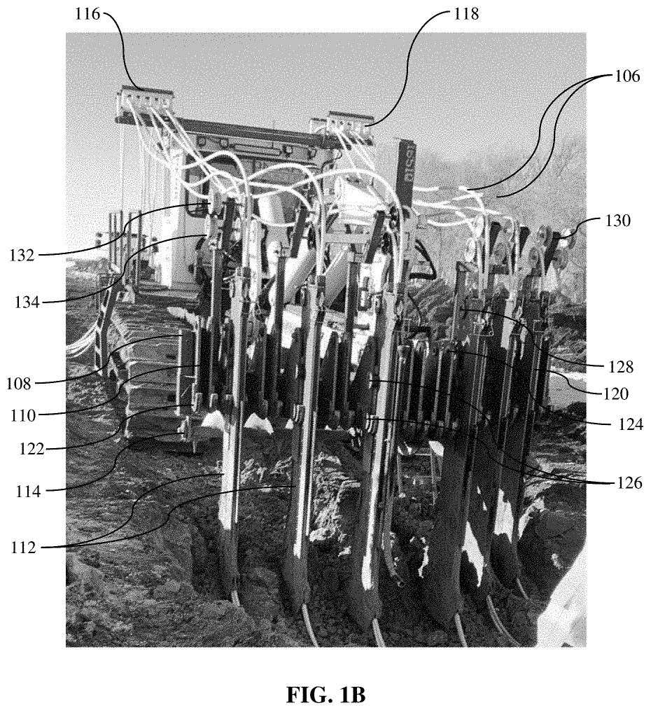

Referring now to FIGS. 1A-1B, system 100 for simultaneously installing multiple cables underground is depicted, according to an embodiment. FIGS. 1A-1B depict system 100 before it has begun to install cables in order to provide a more complete view of the entire system. System 100 generally comprises cable plow 102, cable plow attachment 104, and cables 106. In embodiments, cable plow attachment 104 can comprise frame 108 including slots 110, shanks 112, and hydraulic auger 114.

Referring to FIGS. 1A-1B, cable plow 102, cable plow attachment 104, and cables 106 are depicted according to an embodiment. Cable plow 102 is configured to receive and pass cables 106 to cable plow attachment 104 via cable guides 116. In embodiments, cable guides 116 can include receiving apertures 118 configured to separate and prevent tangling of cables 106.

With continued reference to FIGS. 1A-1B, frame 108 is configured to removably attach to cable plow 102 and enable configuration of the desired spacing and depth of cables 106 during the installation process. Frame 108 includes slot walls defining slots 110 configured to removably receive one or more shanks 112. Each of the one or more shanks 112 can removably receive boots 120 through which cables 106 can pass. Therefore, frame 108 can comprise a plurality of slots in which to place shanks 112 to facilitate greater flexibility in the arrangement of cables. During operation, slots 110 can remain empty such that shanks 112 can be selectively placed in slots 110 to achieve desired spacing between cables 106 based on the specifications and requirements of the project at hand.

Proximate to each of the series of slots 110, frame 108 can comprise one or more attachment means with which to removably attach shanks 112. In embodiments, frame 108 can include one or more of hooks 122 and frame apertures 124. In embodiments, shanks 112 can include corresponding attaching means such as one or more protrusions 126 and one or more shank apertures 128. In such embodiments, attaching means can be spaced such that shanks 112 can be coupled at differing heights relative to the cable plow. In some embodiments, one or more shanks 112 can be disposed in each slot 110.

In operation, shanks 112 can be vertically or horizontally adjusted relative to frame 108 by selecting a particular protrusion 126 to rest on a hook 122 proximate to the desired slot 110. Similarly, a particular shank hole 128 can be aligned with a frame hole 124 such that a locking pin can be inserted. In embodiments, shanks 112 have at least two shank apertures 128 (e.g., a low hole and a high hole) through which they can be attached to frame 108. The frame itself also can be adjusted vertically relative to cable plow 102, for example, between a span of feet.

Shanks 112 comprise a first end configured to receive cable 106 from cable plow 102 and a second end configured to guide the laying of the cable 106 on the ground. Optionally, rollers 130 can be included as part of cable plow 102 or cable plow attachment 104. In embodiments, rollers 130 can comprise a top roller 132 and a bottom roller 134 configured to separate and guide cables 106 into top ends of boots 120 at the first end of shanks 112.

The second end of shanks 112 includes on one side pointed in the direction of forward movement of cable plow 102 comprising plowing means that cuts the earth, lifts up the earth (and displaces rocks), to create grooves in which the cables are laid. The plowing means can include blades, teeth, and the like with one or more lift plates (e.g., triangular/planed) according to embodiments. The other, backwards-facing, side of the second end of shanks 112 includes an outlet where cables 106 exit bottom end of boots 120.

Shanks 112 are housings that house boots 120, through which cables 106 pass, according to embodiments. Boots 120 have smooth interiors for ease of passing through cables 106. Boots 120 can be welded to the shanks 112, or optionally be detachable from shanks 112. In some embodiments, a single boot 120 can include grooves, notches, or slots for one or more cables. For such embodiments, the distance between the one or more cables within the boot may be dependent on heat dissipation and electrical interference. Inclusion of two cables within one shank 112 can be beneficial as both positive and negative lines can be laid proximate to one another.

Optional detachability of shanks 112 and boots 120 is advantageous because cable plow 102 does not have to stop operating or moving forward for a prolonged time in order for a particular set of cables 106 to be added or removed. For example, in the context of placing DC cables for use with solar panels, it is common for the electrical inverters to be varying distances away from the disconnects. In that case, a particular set of cables, such as a set of two cables (e.g., positive, and negative), can be selectively added or removed from the cable plow attachment when an inverter is first reached.

In operation, shanks 112 and boots 120 can be detached from frame 108, moved off cable plow 102, and left in the ground by a first crew. The first crew then measures the final length of cable 106 needed for that run and cuts the cable. Meanwhile, a second crew can dig up the shank 112 and boot 120, remove the cables, and coil or lay the cables out. While the first crew and second crew work, cable plow 102 can keep going toward the next destination. Thus, staggered cable lengths of the plurality of cables can be formed more easily than conventional methods. Although embodiments have been described with regard to cable plow 102, other machines can be used in conjunction with cable plow attachment 104.

In embodiments, hydraulic auger 114 can assist shanks 112 in clearing soil. Hydraulic auger 114 displaces dirt dug up by the plowing means of shanks 112 to ease any clogging and permit better operation. Hydraulic auger 114 outwardly displaces dirt in opposite directions from the center of the auger. In embodiments, hydraulic auger 114 includes fighting positioned in opposite spiraling directions, such that dirt and debris is moved outwardly while the axle of the auger rotates in a single direction. Hydraulic auger 114 flighting could be changed to displace dirt on either side of cable plow attachment 104.

In embodiments, the ultimate spacing of cables can vary depending on project needs. For example, in some situations the gauge and diameter of the cables must be enlarged as one gets closer to the substation and the volume of electricity peaks. In other situations, narrower or further spacing may be preferable depending on factors such as the number of cables. Cables can be spaced adjacent to one another or feet apart according to embodiments. In one embodiment, the cable plow attachment can install cables between six to nine inches apart.

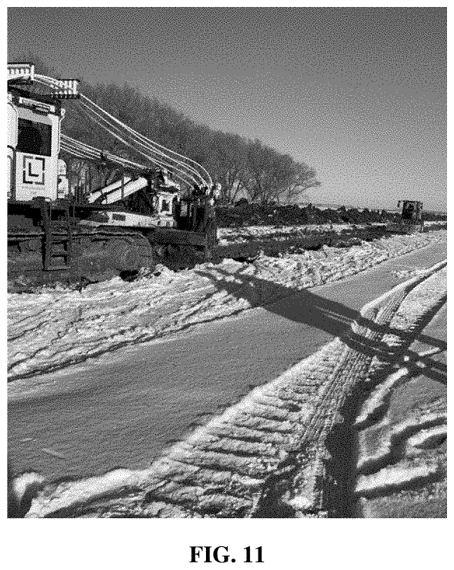

For example, the embodiment of cable plow attachment 104 depicted in FIGS. 1A-1B is configured to install six circuits (twelve total cables) in a single pass with each circuit being a minimum of nine inches apart. This installation can be done with no open trench and therefore no need to dewater an open trench if it rains. In embodiments, another machine can compact dirt behind the cable plow to the specified compaction of any particular project as shown in FIG. 11. In embodiments, frame 108 can include varying numbers of slots 110 configured to receive shanks 112.

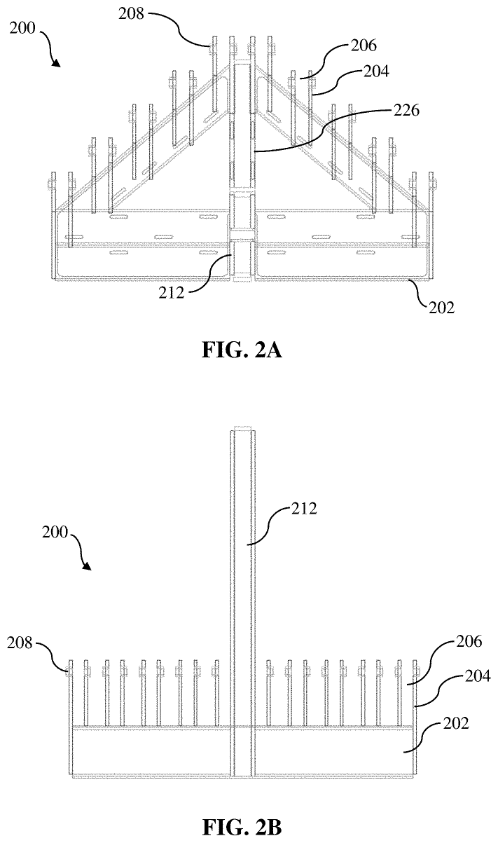

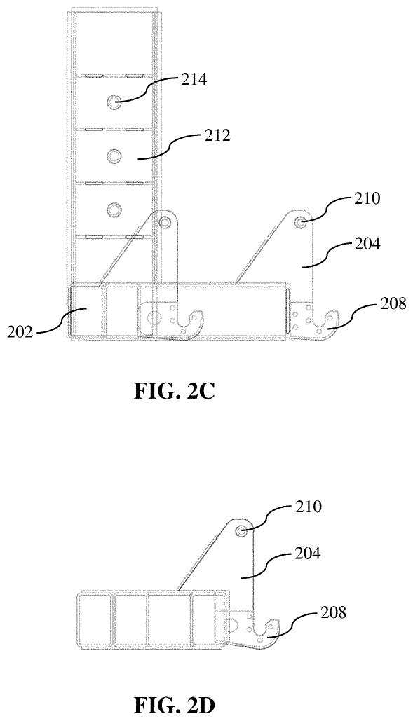

Referring to FIGS. 2A-2D cable plow attachment 200 is depicted according to an embodiment. Cable plow attachment 200 comprises frame 202 having features similar to those of frame 100. Frame 202 includes slot walls 204 defining slots 206, hooks 208, and frame apertures 210. Frame 202 can optionally include support structure 226 configured to provide structural support by distributing weight across frame 202 more evenly.

Frame 202 includes beam 212 configured to removably inserted into a plow box of a cable plow. Once beam 212 is inside the plow box of a cable plow it can be pinned via pin apertures 214 or otherwise secured in place at a desired height. The configurability of the height of cable plow attachment can be used in conjunction with adjustable shanks to provide precise control of the depths of cables.

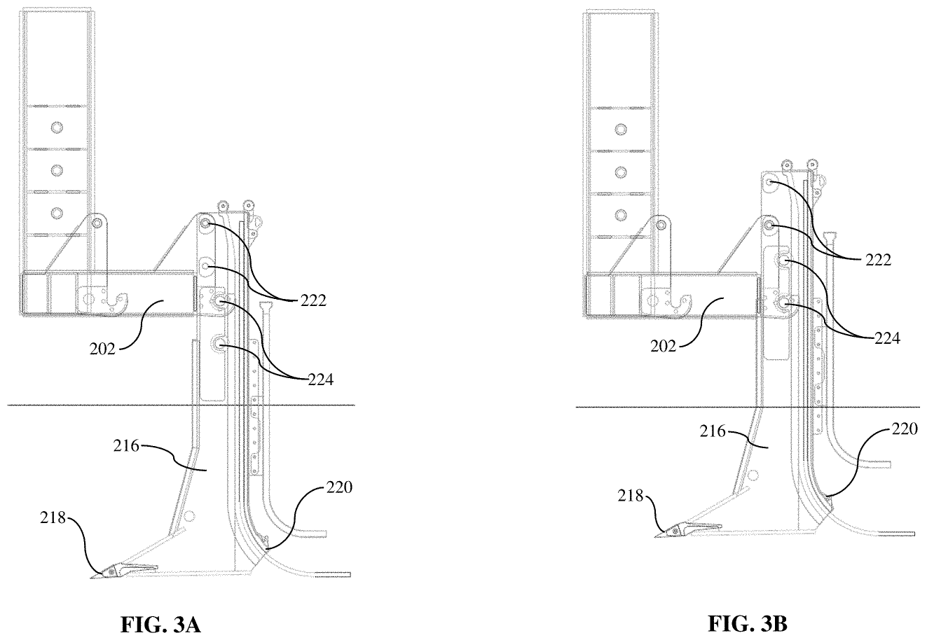

Referring to FIGS. 3A and 3B, frame 202 is depicted connected to shank 216 according to an embodiment. Shank 216 includes an excavation end comprising removable plow tooth 218 and a cable deployment end comprising an outlet of boot 220. Shank 216 can be coupled to frame 202 using protrusions 224 resting on hooks 208 and shank apertures 222 aligning with frame apertures 210 before being pinned or otherwise coupled. Shank 216 can be connected to frame 202 in a lowered position, as shown in FIG. 3A, or a raised position, as shown in FIG. 3B. In embodiments, shanks can include one or more protrusions 224 and shank apertures 222 to allow for more precise customization of shank height relative to frame 202.

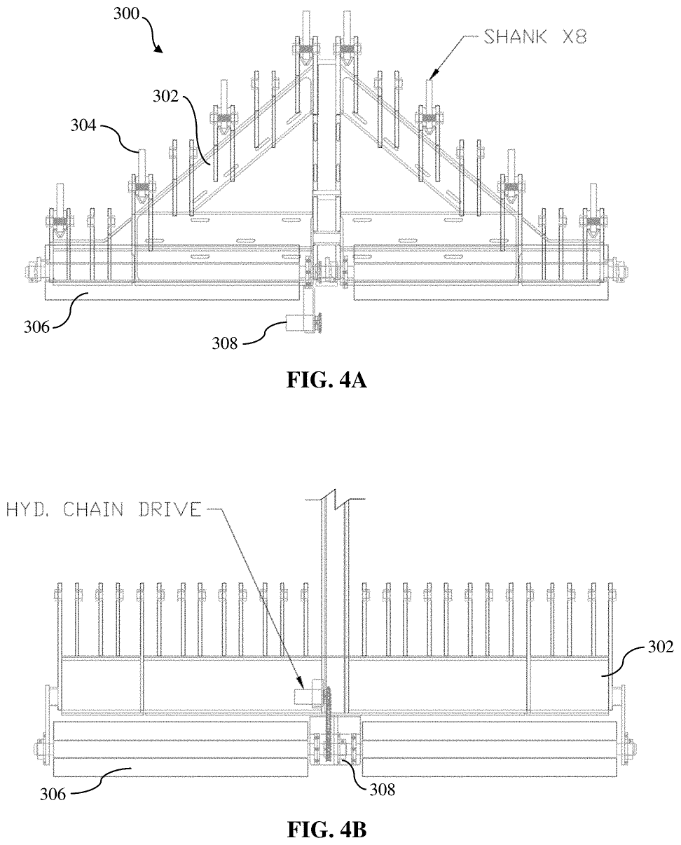

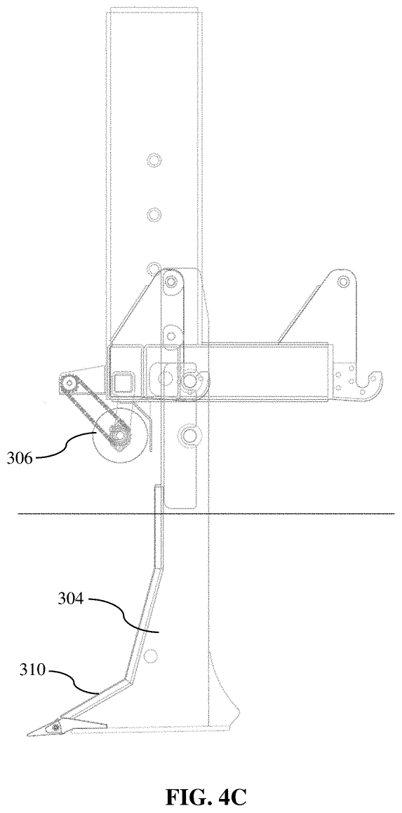

Referring to FIGS. 4A-4C, cable plow attachment 300 including frame 302, shanks 304, and hydraulic auger 306 including chain drive 308 is depicted according to an embodiment. Frame 302 and shanks 304 are operationally similar to frame 202 and shank 216 respectively. Hydraulic auger 306 serves to clear buildup of dirt or debris that otherwise may not pass through the gaps between shanks 304. In embodiments, hydraulic auger 306 can include, for example, one or more chain drives 308. In embodiments, cable plow attachment 300 can comprise one or more hydraulic augers 306. Hydraulic auger 306 is generally positioned on the excavation side of shanks 304 to clear excess debris buildup in front of frame 302. In embodiments, shanks 304 can comprise plating 310.

In embodiments, the staggered positioning of shanks 304 can result in easier access when adding or removing shanks 304. The staggered positioning can further improve weight distribution when more shanks 304 are present on one side of frame 302. Further still, the staggered positioning can improve the flow of dirt and debris around shanks 304 during operation, preventing buildup.

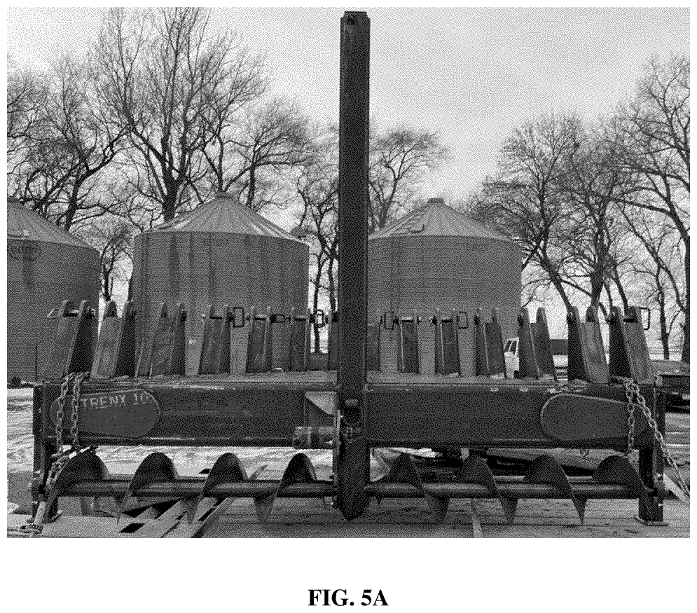

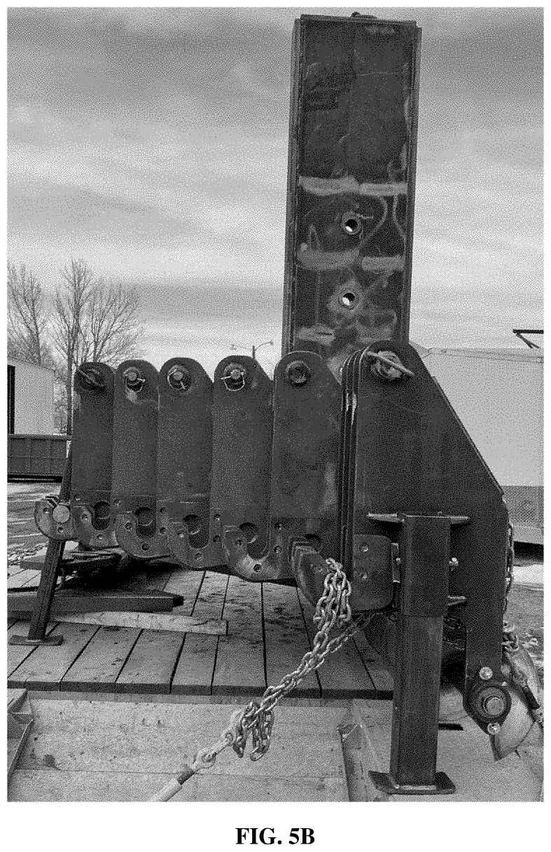

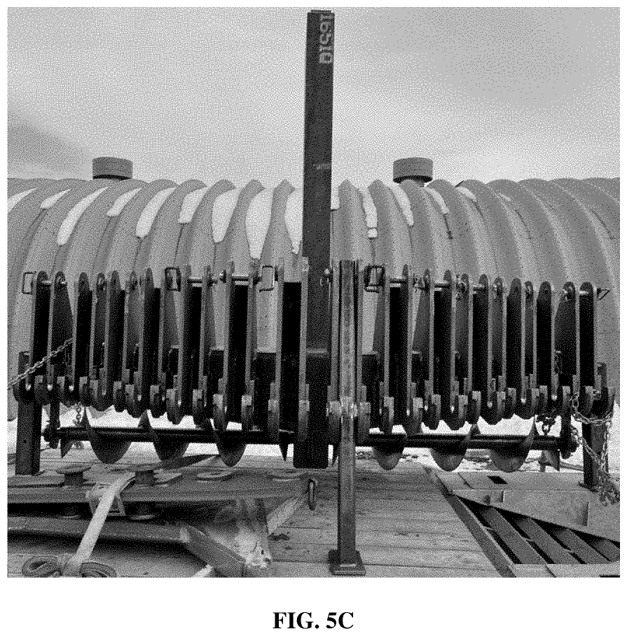

FIGS. 5A-C are photographs of a cable plow attachment according to an embodiment.

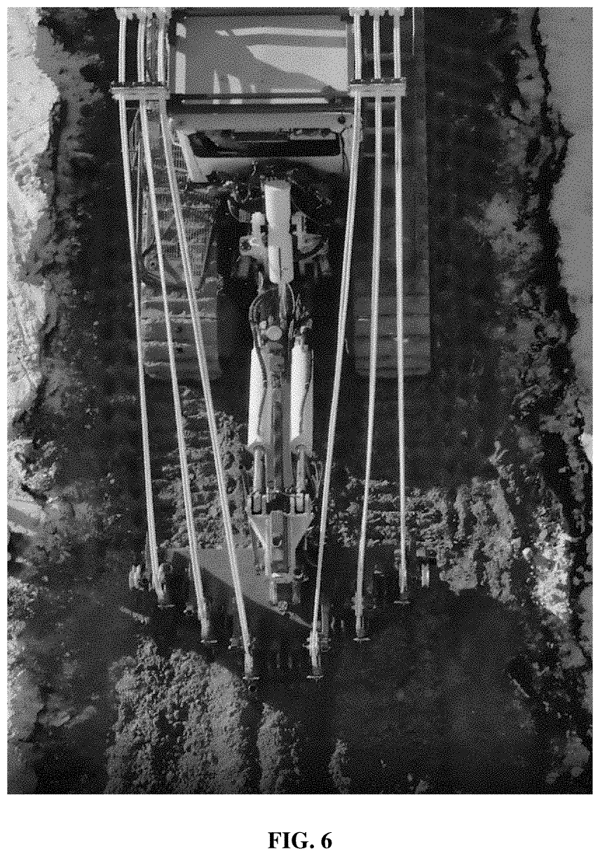

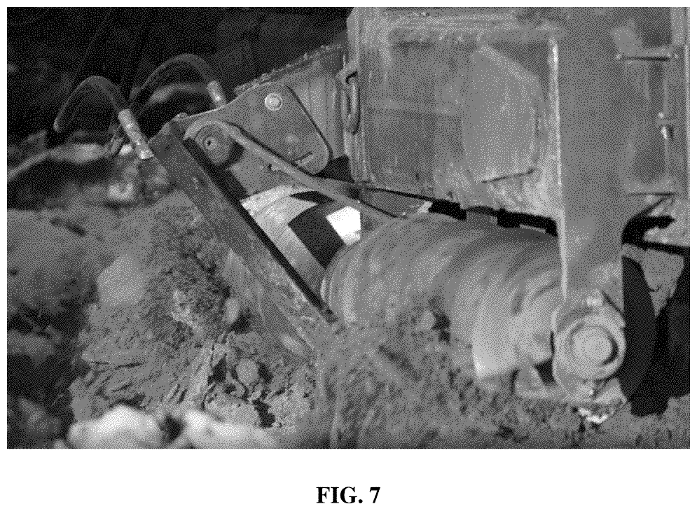

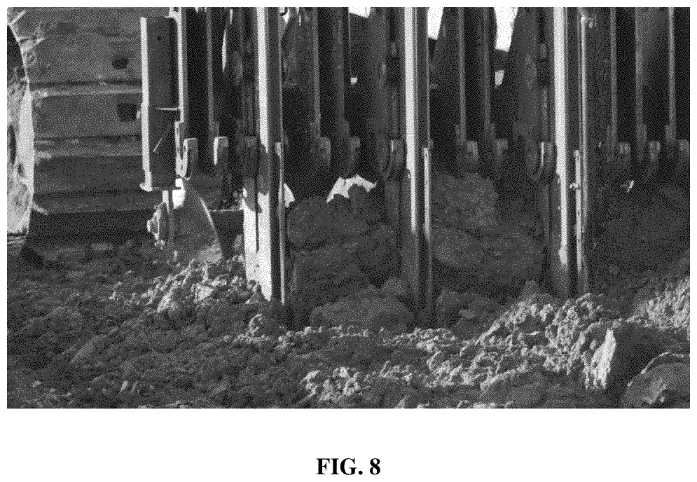

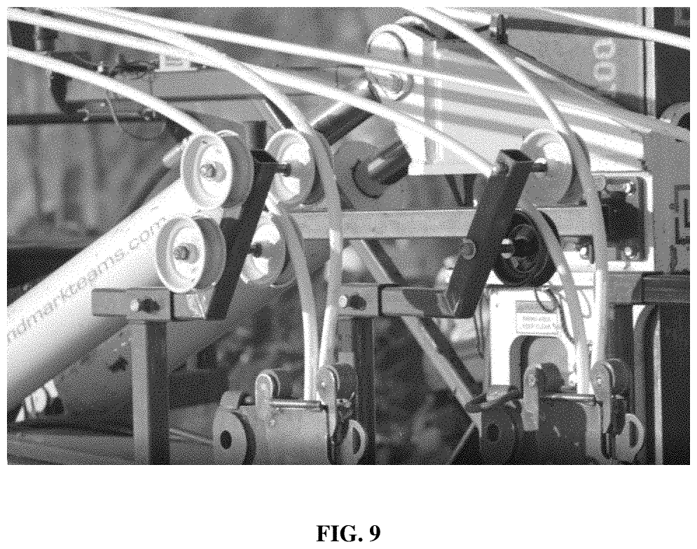

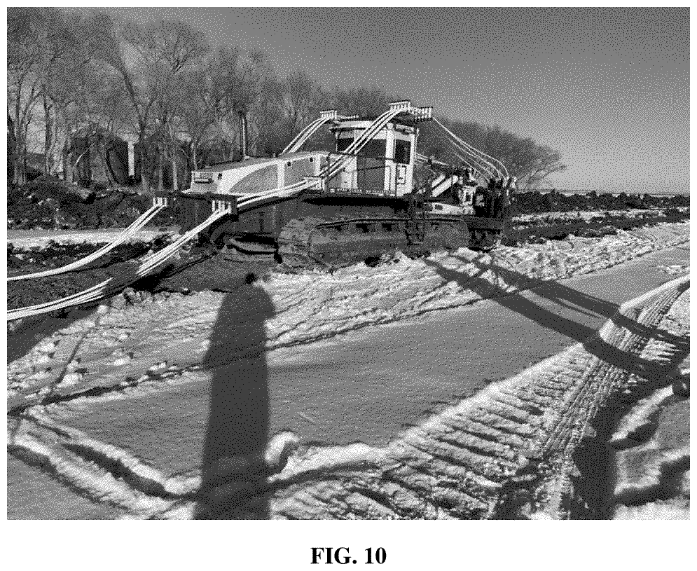

FIGS. 6-11 are photographs of various portions of a cable plow attachment in use according to an embodiment.

Embodiments of the cable plow attachment are capable of simultaneously installing multiple cables at different depths, varying spacing, and in different configurations based on what the construction plans are specifying.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A cable plow attachment, comprising:
a frame configured to removably attach to and extend from a plow box of a cable plow, the frame defining a plurality of slots;
one or more shanks, wherein each of the one or more shanks are configured to removably couple to one of the plurality of slots and comprise:
a first end configured to direct one or more cables through a boot coupled to the shank, and
a second end having,
an excavation side facing the direction of movement of the cable plow and including a plowing portion configured to dig a groove, and
an installation side facing opposite the excavation side and including an outlet configured to position the one or more cables in the groove.

2. The cable plow attachment of claim 1, wherein the plowing portion is one or more of a blade, a tooth, and a lift plate.

3. The cable plow attachment of claim 1, further comprising a hydraulic auger coupled to the frame, wherein the hydraulic auger is configured to outwardly displace dirt and debris.

4. The cable plow attachment of claim 1, wherein the one or more slots are staggered relative to the direction of movement of the cable plow.

5. The cable plow attachment of claim 1, wherein the one or more shanks comprise plating.

6. The cable plow attachment of claim 1, wherein the frame further comprises at least one hook proximal to each of the plurality of slots and each of the one or more shanks comprises at least one protrusion configured to rest on one of the at least one hooks when coupled to the corresponding one of the plurality of slots.

7. The cable plow attachment of claim 1, wherein the frame further defines at least one frame aperture proximal to each of the plurality of slots and each of the one or more shanks defines at least one shank aperture such that when each of the one or more shanks is coupled to one of the plurality of slots the at least one frame aperture and the at least one shank aperture align and are configured to removably receive a locking pin.

8. The cable plow attachment of claim 6, wherein the at least one hook comprises a first hook and a second hook proximal to each of the plurality of slots and each of the one or more shanks can be coupled to the frame in a lowered position when the at least one protrusion rests on the first hook and can be coupled to the frame in a raised position when the at least one protrusion rests on the second hook.

9. The cable plow attachment of claim 1, wherein the frame defines six slots.

10. The cable plow attachment of claim 1, wherein the frame includes rollers configured to separate and guide cables into the boot.

11. The cable plow attachment of claim 1, wherein each of the plurality of slots is spaced at least six inches apart.

12. The cable plow attachment of claim 1, wherein the boot includes one or more of grooves, notches, or apertures for receiving a cable.

13. The cable plow attachment of claim 1, wherein the boot is configured to receive two cables.

14. The cable plow attachment of claim 13, wherein the distance between the two cables within the boot is dependent on heat dissipation and electrical interference.

15. The cable plow attachment of claim 13, wherein the two cables comprise a positive cable and a negative cable.

16. A method of laying cables, comprising:
coupling one or more shanks to a plurality of slots on a frame coupled to a cable plow, wherein each shank comprises:
a first end configured to direct one or more cables through a boot coupled to the shank, and
a second end comprising:
an excavation side including a plowing portion configured to dig a groove, and
an installation side facing opposite the excavation side and including an outlet configured to position the one or more cables in the groove;
passing one or more cables through the first end of the one or more shanks
operating the cable plow to move forward in a desired direction while the one or more shanks dig the groove using the plowing portion of the excavation side and position the one or more cables in the groove using the outlet of the installation side.
